(19) United States
(12) Patent Application Publication
(10) Pub. No.: US 2006/0192524 A1
(43) Pub. Date: Aug. 31, 2006

(54) Safety device for booster cables kit for vehicles

(76) Inventor: Su-Ching Lin, Taichung City (TW)

Correspondence Address: CHARLES E. BAXLEY, ESQ., 90 JOHN STREET, THIRD FLOOR, NEW YORK, NY, 10038, US

(21) Appl. No.: 11/068,022

(22) Filed: Feb. 28, 2005

(51) Int. Cl. H02J 7/00

(52) U.S. Cl. 320/105

(57) ABSTRACT

A booster cables kit includes a battery having a first booster cable connected to a positive pole terminal and a second booster cable connected to a negative pole terminal. A detection cable is connected between the first clamp and a circuit board which is connected to a switch device which is connected between the second clamp and the negative pole terminal. The circuit board detects the connection of the two booster cables and the battery to be restarted, if the connection is wrong, the circuit board sends a signal to cut off the circuit of the connection, if the connection is detected to be correct, the switch device is pressed and the battery to be restarted is activated by the battery of the kit

### FIELD OF THE INVENTION

The present invention relates to a safety device for detecting poles when using booster cables to re-start engine of vehicles to prevent unexpected sparks due to wrong connection.

### BACKGROUND OF THE INVENTION

A conventional booster kit for restart a vehicle with a lower battery is disclosed in FIG. 1, and generally includes a battery 10 with a positive pole terminal 101 and a negative pole terminal 102, two booster cables 11 and 12 are respectively connected to the two pole terminals 101 and 102. Two clamps 20 21 are respectively connected to the two booster cables 11, 12 so as to respectively clamp two poles on the battery that needs to be restarted. The two clamps 21, 22 each have a conductive portion 210/211 so as to be connected to the two respective booster cables 11, 12 and the conductive portions 210, 211 are directly in contact with the positive and negative poles of the battery to be restarted. However, if the user wrongly connects the clamp 20 connected to the positive pole terminal 101 of the rescue battery to the negative pole of the battery to be restarted, and the clamp 21 connected to the negative pole terminal 102 of the rescue battery to the positive pole of the battery to be restarted, sparks could generate and cause fire which is extremely dangerous.

The present invention intends to provide a safety device connected with the booster cables so as to detect the connection of the booster cables and the battery to be restarted to prevent sparks generated due to wrong connection.

### SUMMARY OF THE INVENTION

The present invention relates to a booster cables kit which comprises a battery having a positive pole terminal connected with a first booster cable and a negative pole terminal connected with a second booster cable. Each of the two booster cables has a clamp connected thereto. A detection cable has one end connected to one of the two clamps and the other end of the detection cable is connected to a circuit board which is connected to a switch device connected between the other clamp and the negative pole terminal.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional booster cable kit;

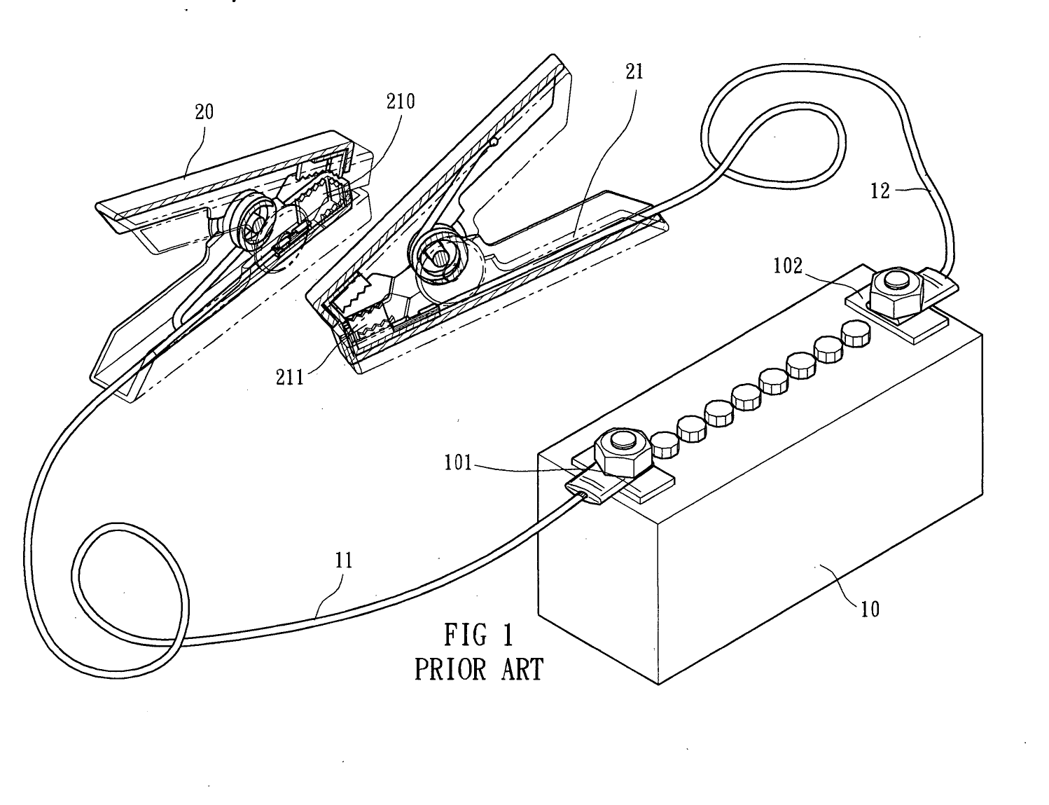

FIG. 2 shows the booster cable kit of the present invention, and

FIG. 3 shows the booster cable kit of the present invention connected to a vehicle battery to be restarted.

### DETAILED DESCRIPTION OF THE PREFERRED EMBODIMENT

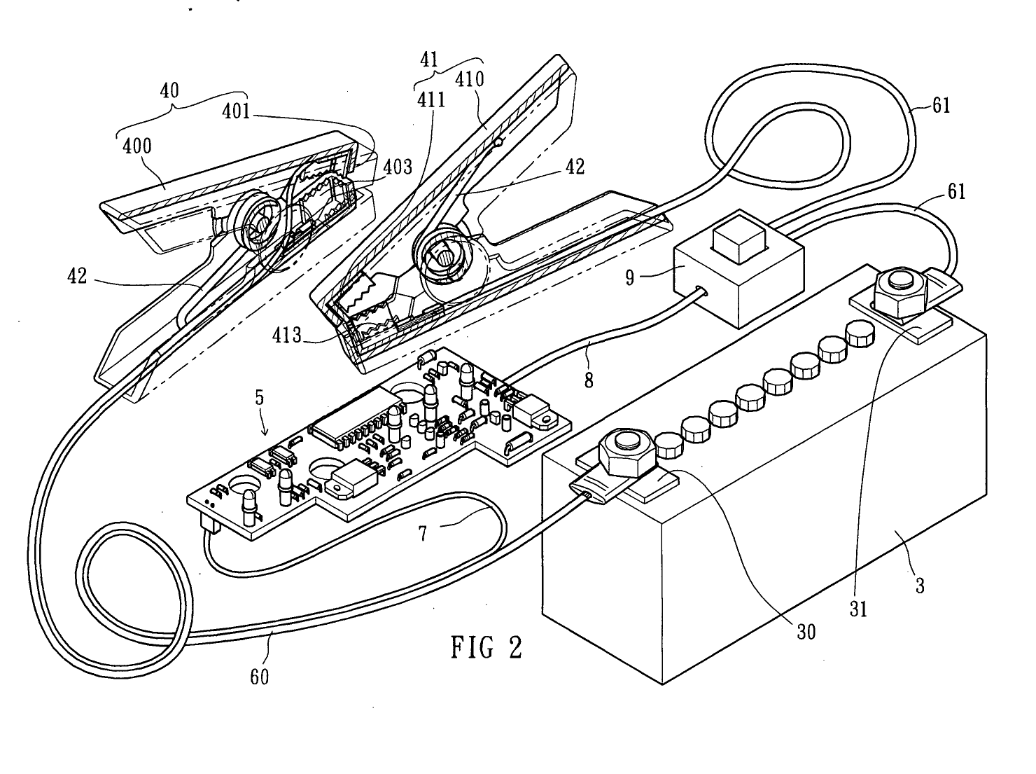

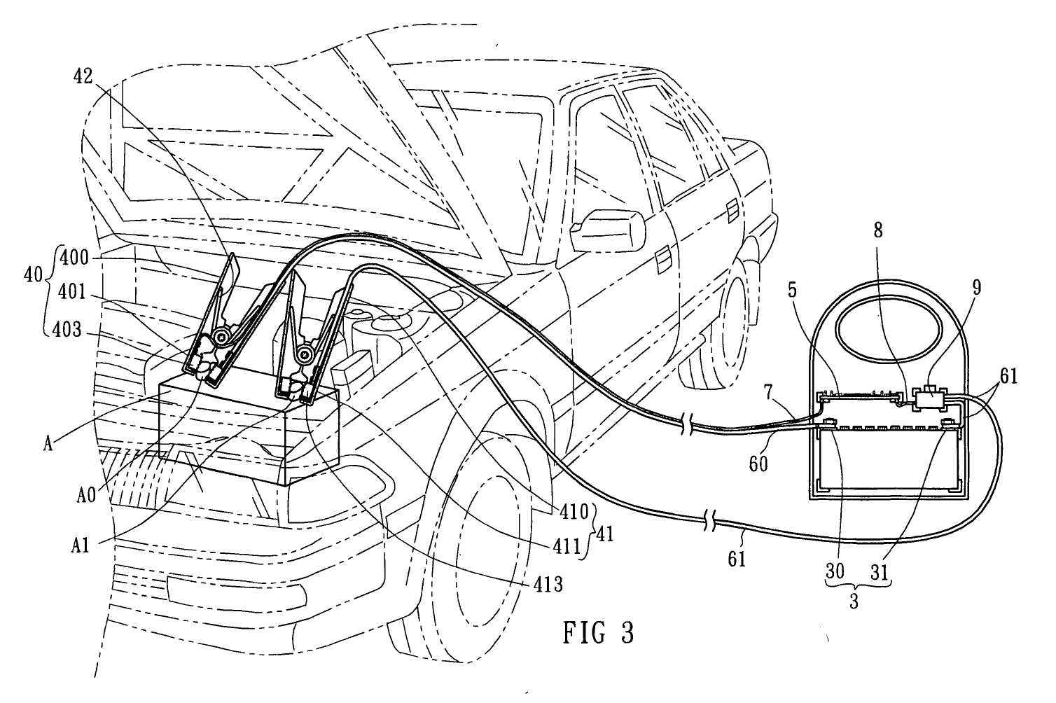

Referring to FIGS. 2 to 3, the booster cable kit of the present invention comprises a battery 3 having a positive pole terminal 30 connected with a first booster cable 60 and a negative pole terminal 31 connected with a second booster cable 61. A first clamp 40 is connected to the first booster cable 60 and a second clamp 41 connected to the second booster cable 61. Each of the first and second clamps 40, 41 is composed of two clamp parts 400 which are pivotably connected with each other and a torsion spring 42 is biased between the two clamp parts 400 of each of the first and second clamps 40, 41. A first conductive portion 403 is connected to a clamp end 401 of the first clamp 40 so that a detection cable 7 and the first booster cable 60 are connected to the conductive portion 401. A second conductive portion 413 is connected to a clamp end 411 of the second clamp 41 so that the second booster cable 61 is connected to the conductive portion 411.

The detection cable 7 has one end connected to the first clamp 40 and the other end of the detection cable 7 is connected to a circuit board 5. A switch-device 9 with a button is connected to the circuit board 5 by a connection cable 8. The switch device 9 is connected to the second booster cable 61 and located between the second clamp 41 and the negative pole terminal 31.

When connecting the first and second booster cables 60, 61 to the positive pole terminal “A0” and the negative pole terminal “A1” of a vehicle battery “A” to be restarted as shown in FIG. 3, the circuit board 5 detects the connection of the booster cables 60, 61 and the positive and negative pole terminals “A0”, “A1”. If the connection is correct, the circuit board 5 generates a signal to the switch device 9 so that when the user presses the button on the switch device 9, the circuit is connected and electric current can be transferred to the vehicle battery “A” which is activated. If the circuit board 5 detects that the connection is incorrect, the circuit board 5 cuts off the circuit so that even if the user presses the button, no current is transferred via the first booster cable 60 and the second booster cable 61.

The booster cable kit of the present invention avoid the users to wrongly operate the booster cable kit. In other words, the users are notified if the booster cables 60, 61 are wrongly connected. There are many known way to notify the users, such as by using a flash light, an audio device or any other device.

While we have shown and described the embodiment in accordance with the present invention, it should be clear to those skilled in the art that further embodiments may be made without departing from the scope of the present invention.

What is claimed is:

1. A booster cables kit, comprising:
a battery having a positive pole terminal connected with a first booster cable and a negative pole terminal connected with a second booster cable, a first clamp connected to the first booster cable and a second clamp connected to the second booster cable, a detection cable having one end connected to the first clamp and the other end of the detection cable connected to a circuit board, a switch device connected to the circuit board by a connection cable, the switch device connected to the second booster cable and located between the second clamp and the negative pole terminal.

2. The kit as claimed in claim 1, wherein each of the first and second clamps is composed of two clamp parts which are pivotably connected with each other and a torsion spring is biased between the two clamp parts of each of the first and second clamps, the first clamp having a first conductive portion connected to a clamp end thereof and the detection cable and the first booster cable connected to the conductive portion, the second clamp having a second conductive portion connected to a clamp end thereof and the second booster cable connected to the conductive portion.

3. The kit as claimed in claim 1, wherein the circuit board generates a signal to cut off the circuit when the first and second booster cables are wrongly connected.
